(19) United States
(12) Patent Application Publication
(10) Pub. No.: US 2022/0377059 A1
(43) Pub. Date: Nov. 24, 2022

(54) LONG-TERM KEY MANAGEMENT FOR END-TO-END ENCRYPTION OF VIDEOCONFERENCES

(71) Applicant: Zoom Video Communications, Inc., San Jose, CA (US)

(72) Inventors: Karan Lyons, Los Angeles, CA (US); Simon Booth, Livermore, CA (US)

(73) Assignee: Zoom Video Communications, Inc., San Jose, CA (US)

(21) Appl. No.: 17/327,295

(22) Filed: May 21, 2021

(51) Int. Cl. H04L 29/06

(52) U.S. Cl. CPC H04L 63/065; H04L 65/403; H04L 63/0428

(57) ABSTRACT

One example system for providing long-term key management for end-to-end encryption of videoconferencing information includes a processor and at least one memory device. The memory device includes code for causing the processor to generate one or more persistent cryptographic keys for a specific client device. A persistent key can be stored in or on the specific client device. A mapping of the key to a client device identifier can be transmitted to the video conference provider and can enable the video conference provider to set up videoconferences with per client encryption. A processor at the video conference provider can distribute the key for each client device to one or more participants in a videoconference to enable the client devices to end-to-end encrypt the videoconference.

### FIELD

The present application generally relates to videoconferences and more particularly relates to systems and methods for providing encryption of videoconference communication.

### BACKGROUND

Videoconferencing has become a common way for people to meet as a group, but without being at the same physical location. Participants can be invited to a videoconference meeting, join from their personal computers or telephones, and are able to see and hear each other and converse largely as they would during an in-person group meeting or event. The advent of user-friendly videoconferencing software has enabled teams to work collaboratively despite being dispersed around the country or the world. It has also enabled families and friends to engage with each other in more meaningful ways, despite being physically distant from each other.

### SUMMARY

Various examples are described for systems and methods for providing long-term key management for end-to-end encryption of videoconferencing information. One example non-transitory computer-readable medium includes code that is executable by a processor for causing the processor to generate a persistent key pair including an identify verifying key (IVK) and an identity signing key (ISK), and produce a mapping of the IVK to a device identifier (device ID) for a videoconferencing client device. The code is further executable by the processor for causing the processor to sign the mapping using the ISK, and transmit the mapping to a video conference provider. The mapping is configured to enable the video conference provider to provide per client end-to-end encryption, and can be used to encrypt a videoconference including the videoconferencing device client.

One example system includes a processor, and at least one memory device including instructions that are executable by the processor. The instructions can cause the processor to receive, a client-generated, persistent key from a user client device and receive a device ID corresponding to the user client device. The instructions can further cause the processor to store the client-generated, persistent key in the at least one memory device in association with the device ID for the user client device. The client-generated, persistent key is configured for per client end-to-end encryption. The instructions can cause the processor to distribute the client-generated, persistent key to at least one participant in a videoconferencing session including the user client device and to end-to-end encrypt a videoconference including the user client device and the participant.

One example method includes receiving, by a video conferencing system, a persistent key and a device ID corresponding to a user client device and storing, by the video conferencing system. The persistent key is associated with the device ID of the user client device. The persistent key is configured for per client end-to-end encryption. The method further includes distributing, by the video conferencing system, the persistent key to at least one participant in a videoconferencing session including the user client device, and end-to-end encrypting a videoconference including the user client device and the participant by using the persistent key.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-4 illustrate example systems to enable long-term key management for end-to-end encryption of videoconferencing information;

FIG. 5 and FIG. 6 illustrate example methods for providing long-term key management for end-to-end encryption of videoconferencing information; and

FIG. 7 shows an example computing device suitable for use with any disclosed systems or methods according to this disclosure.

### DETAILED DESCRIPTION

Examples are described herein in the context of systems and methods for providing client-based, long-term key management for end-to-end encryption of videoconferencing information. Videoconferencing information can include audio and video streams, as well as data moving between devices. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Videoconferencing systems enable their users to create and attend videoconferences (or “meetings”) via various types of client devices. After joining a meeting, the participants receive audio and video streams or feeds (or “multimedia” streams or feeds) from the other participants and are presented with views of the video feeds from one or more of the other participants and audio from the audio feeds. Using these different modalities, the participants can see and hear each other, engage more deeply, and generally have a richer experience despite not being physically in the same space.

To create a meeting, a person (referred to as the “host” or “meeting host”) accesses the videoconferencing system, schedules a new meeting, and identifies one or more other people to invite to the meeting. In response to the host creating the meeting, the videoconference system establishes the meeting by creating a meeting identifier and, if desired, a passcode or other access control information. The host can then send the meeting identifier (and access control information) to each of the invitees, such as by email. Once the meeting is started, the invitees can then access and join the meeting using the meeting identifier and any provided access control information. The initial, or main host can, in some systems, make another participant a co-host. For purposes of the discussion herein, the term “host” encompasses hosts and co-hosts. Hosts can manage and control the videoconferencing session.

Existing videoconferencing systems may provide for encryption of videoconferencing information. As examples, these system may provide for encryption between user's client devices and the servers of the video conference provider. In some cases, the server needs to decrypt data streams to provide different encryption formats, to make cloud-based recordings, or for other purposes. Sometimes this encryption is accomplished with a per meeting key. While these encryption techniques provide good security, a videoconference in process can still be compromised if the meeting server is compromised before or during the meeting.

End-to-end encryption between client devices can eliminate the exposure that results from the server decrypting videoconference contents during a meeting. End-to-end encryption can be provided by an entity in the system obtaining a cryptographic meeting key and providing it to all of the client devices when setting up the meeting. The key is then used to encrypt streams between devices. The meeting key is not provided to the meeting server, and, thus, these streams are not decrypted at the meeting server. While this provides improved security relative to server-based encryption, the same key is used throughout the system for all meeting information and the entity that provides that key can be compromised.

To provide a more secure videoconference, a videoconferencing system according to this disclosure enables every client device running a user client application to generate and manage its own long-lived public/private key pair. The private key is known only to the user client device. When these keys are used for end-to-end encryption, each device's key is used for videoconference meeting information streaming from that client device to the other devices, providing per client, end-to-end encryption so that different portions of the meeting data streams are encrypted with different client-generated, persistent keys. Other encryption, such as with a meeting key, can be imposed on top of these encrypted streams if desired. The public keys can be exchanged through a signaling channel as part of the meeting setup. The key pair is stored on the client device, for example, in the operating system keychain, optionally with key-wrapping to enable multiple users with different login credentials to use the same key pair.

A videoconferencing client application can generate, for its device, a persistent key pair including a public key and a private key. The client application may use a certificate authority, its device's own security element, or any other mechanism to generate the key pair. The client application can do this when prompted, for example, when the device or the client application is registered (provisioned) with the video conference provider, or when the client application is first used for a videoconference where end-to-end encryption is enabled. The client application can also optionally generate a random key-wrapping key for the key pair to render distinctive copies of the device-specific encryption key pair to be stored in the client device's keychain for each of multiple users.

One or more servers at the video conference provider can receive the client-generated, persistent keys from the user client devices along with the device identifiers (device IDs) as part of a device provisioning process or during meeting set-up and store these mappings. The individual keys can be distributed to participants' devices as needed when a meeting is being set up. The video conference provider can also store one or more key-wrapping keys in association with the device ID and the relevant user identities (User IDs) for the videoconferencing system.

The techniques disclosed herein for providing long-term key management for videoconferencing clients provide for increased security for videoconferences. The techniques prevent a videoconference in process from being compromised by a passive adversary, by eliminating the possibility of easily accessing an encryption key that applies to all devices and streams.

This illustrative example is given to introduce the reader to the general subject matter discussed herein and the disclosure is not limited to this example. The following sections describe various additional non-limiting examples and examples of systems and methods for providing long-term key management for end-to-end encryption of videoconferencing information.

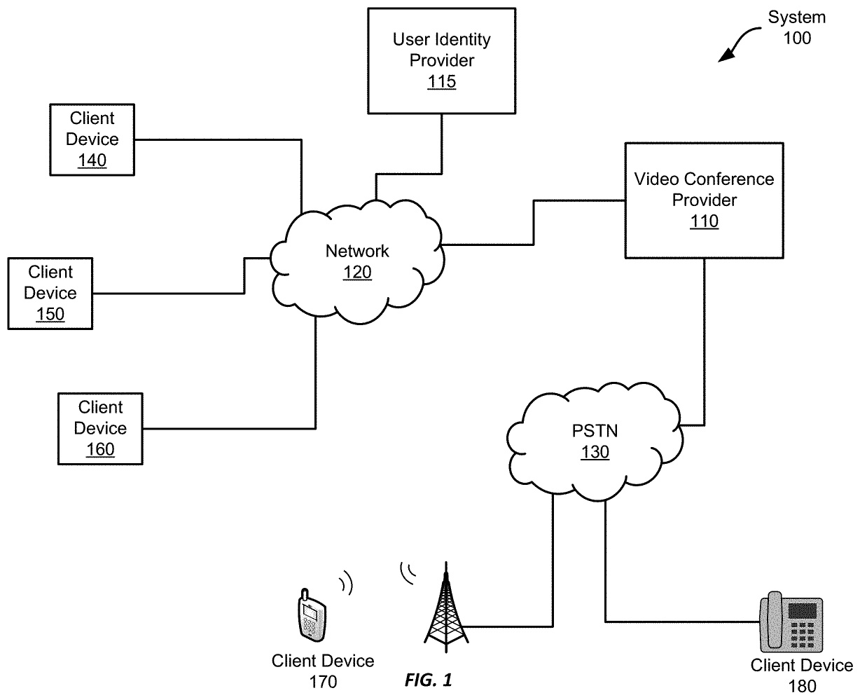

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 110 can be located within a private network to provide video conferencing services to devices within the private network, or it can be connected to a public network, e.g., the Internet, so it may be accessed by anyone. Some examples may even provide a hybrid model in which a video conference provider 110 may supply components to enable a private organization to host private internal video conferences or to connect its system to the video conference provider 110 over a public network.

The system optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity.

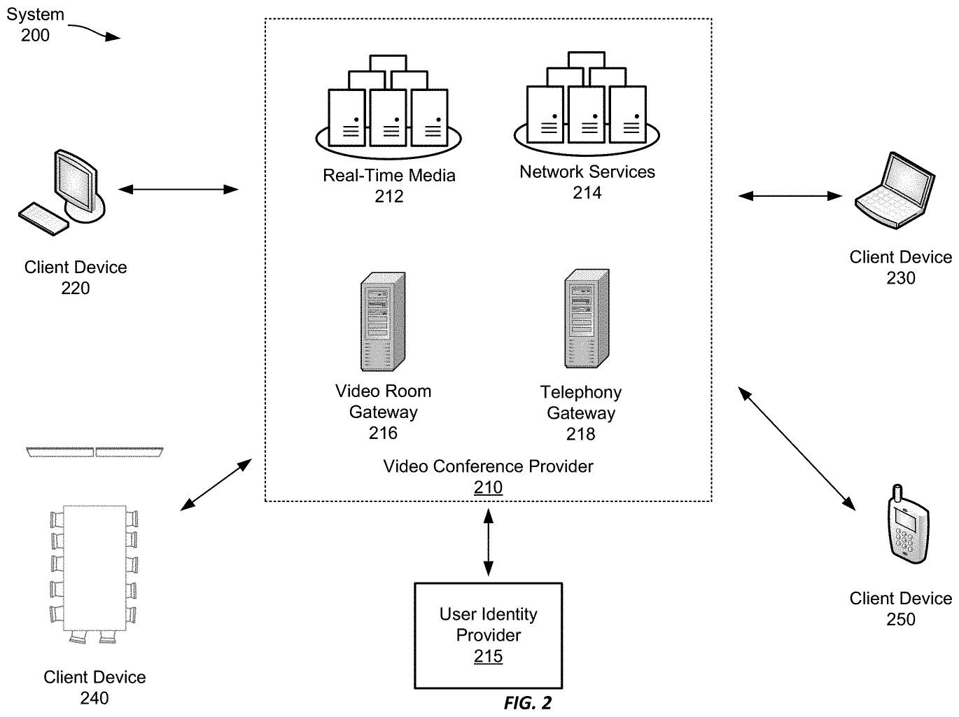

Video conference provider 110 allows clients to create videoconference meetings (or “meetings”) and invite others to participate in those meetings as well as perform other related functionality, such as recording the meetings, generating transcripts from meeting audio, manage user functionality in the meetings, enable text messaging during the meetings, create and manage breakout rooms from the main meeting, etc. FIG. 2, described below, provides a more detailed description of the architecture and functionality of the video conference provider 110.

Meetings in this example video conference provider 110 are provided in virtual “rooms” to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used. Further, in some examples, and as alluded to above, a meeting may also have “breakout” rooms. Such breakout rooms may also be rooms that are associated with a “main” videoconference room. Thus, participants in the main videoconference room may exit the room into a breakout room, e.g., to discuss a particular topic, before returning to the main room. The breakout rooms in this example are discrete meetings that are associated with the meeting in the main room. However, to join a breakout room, a participant must first enter the main room. A room may have any number of associated breakout rooms according to various examples.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating the that meeting has not yet started or the host may be required to specifically admit one or more of the users.

During the meeting, the participants may employ their client devices 140-180 to capture audio or video information and stream that information to the video conference provider 110. They also receive audio or video information from the video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The video conference provider 110 may also invalidate the meeting information, such as the meeting identifier or password/passcode.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs multiple different servers (or groups of servers) to provide different aspects of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed streams to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference provider 210. In some such examples, the real-time media servers 212 may decrypt incoming multimedia streams, multiplex the multimedia streams appropriately for the various clients, and encrypt the multiplexed streams for transmission.

In some examples, to provide multiplexed streams, the video conference provider 210 may receive multimedia streams from the various participants and publish those streams to the various participants to subscribe to and receive. Thus, the video conference provider 210 notifies a client device, e.g., client device 220, about various multimedia streams available from the other client devices 230-250, and the client device 220 can select which multimedia stream(s) to subscribe to and receive. In some examples, the video conference provider 210 may provide to each client device the available streams from the other client devices, but from the respective client device itself, though in other examples it may provide all available streams to all available client devices. Using such a multiplexing technique, the video conference provider 210 may enable multiple different streams of varying quality, thereby allowing client devices to change streams in real-time as needed, e.g., based on network bandwidth, latency, etc.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams.

In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc. Such a system can be implemented in other ways, for example, by the client itself recording a portion of the meeting and providing it as part of the report and/or that the meeting would be constantly recorded into a short “ring buffer” of, e.g., the last 30 seconds, which would then be attached to a report made after the infraction. This “recording” may either be made by the client in plaintext and then sent to the service provider, or made by the server in ciphertext, and the key for that portion of the meeting revealed by the client to reduce the amount of bandwidth required. The latter, however, may require a different rekeying schedule to ensure that the service provider does not obtain more information than the reporter intends.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference provider 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the client device may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, creating sub-meetings or “break-out” rooms, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to create a break-out room for one or more meeting participants to join, such a command may also be handled by a network services server 214, which may create a new meeting record corresponding to the break-out room and then connect one or more meeting participants to the break-out room similarly to how it originally admitted the participants to the meeting itself. In some examples, such actions can actually be handled without server orchestration or entirely through client consensus. For example, the host can nominate a new host by signing a message saying such and relaying it to all participants in the meeting, who will then honor administrative actions signed by that newly elected host. A similar mechanism can be used for removing a user, by the host signing a message saying as such. In such a case, all participants can respond by rekeying as described herein.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider 210 when it is first installed and the video room gateway servers 216 may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

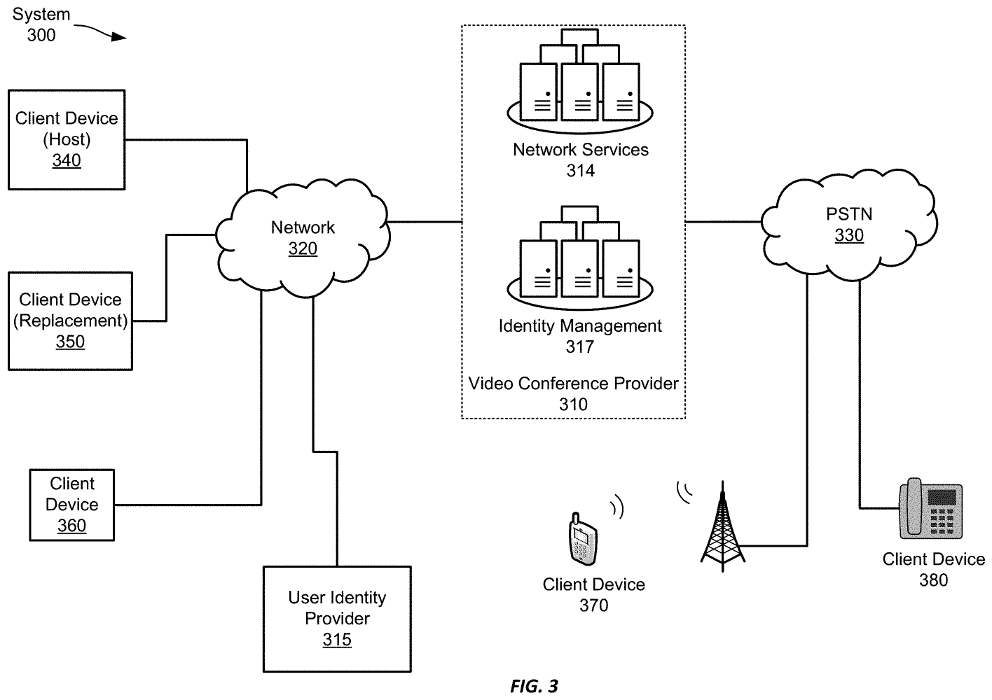

Referring now to FIG. 3, FIG. 3 illustrates an example system 300 including long-term key management for end-to-end encryption of videoconferencing information. FIG. 3 includes components similar to those shown in FIGS. 1 and 2. In this example, the system 300 includes public user identity provider 315 through which individuals can establish identities that may be used to access various online services, including videoconference services provided by the video conferencing system of the video conference provider 310. In this example, when users attempt to access videoconferences hosted by the video conference provider 310, the video conference provider 310 attempts to verify each participant, such as by communicating with the user identity provider 315. User identity provider 315 may, as an example provide single sign-on (SSO) services. User identity provider 315 may also independently include a certificate authority (CA) to provide a user client device with encryption keys including persistent key pairs to be managed for end-to-end encryption of videoconferences as described herein.

When a user establishes an identity with the user identity provider 315, they provide certain personal information, such as a name, address, birth date, email address(es), etc. The user identity provider 315 may then establish an identity for the user that provides certain functionality, such as an identity indicator (e.g., an account or user name), encryption keys, cryptographic signatures, etc., that the user may employ to access various online services. In some examples, the user may be able to connect to the video conference provider 310 and log into an account with the video conference provider 310 using the user identity provider 315 to access functionality provided by the video conference provider 310. However, in some examples, a participant or host of a videoconference may not have, or may not want, an account with the video conference provider 310.

To accommodate such unregistered users, the video conference provider 310 may require users to provide a user identifier, such as an identity established with the user identity provider, before admitting them to a videoconference or allowing them to create a videoconference. After receiving the user's identity and potentially additional information, such as cryptographic information, the network services server(s) 314 operated by the video conference provider 310 may communicate with the user identity provider 315 to verify that the identity is valid and to authenticate the user. After verifying the user's identity, the video conference provider 310 may then admit them to a scheduled meeting or allow them to host a scheduled meeting.

Using such a publicly available user identity provider may provide broader access to videoconferencing services without requiring individuals to register with the video conference provider. This may reduce the burden on the user, who may instead be able to use an existing identity.

Participants in a videoconferencing meeting taking place on system 300 use client devices 340-380 connected either using network 320 or PSTN 330. In this example, the participant using host client device 340 is the host of a videoconferencing meeting. The host may be granted administrative privileges by the video conference provider 310 to allow client device 340 to manage meetings, such as by enabling or disabling screen sharing, muting or removing users from the meeting, creating sub-meetings or “breakout” rooms, recording meetings, etc. Such functionality may be managed by the network services server(s) 314 at the video conference provider 310. The host also serves as a leader in terms of managing the end-to-end encryption of videoconferences using client-generated, persistent key pairs.

The leader typically runs an authorized client application for the video conference provider and the leader's application is responsible for generating a shared meeting key, which is provided to all participants along with keys for end-to-end encryption. For example, the host can enable or disable end-to-end encryption, causing the distribution of identity verification keys (IVKs) for user client devices to establish end-to-end encryption for meeting attendees. An IVK is a public key within the videoconferencing system, and is generated as one of a pair of keys. A key pair includes the public IVK and a private identity signing key (ISK). In some examples, cloud recording can be selectively enabled or disabled based on the end-to-end encryption of a videoconferencing session. For example, the system can disable any cloud-based recording capability and/or end any recording in process when end-to-end encryption is enabled. If and when the host becomes unavailable, a new leader to provide end-to-end encryption control can be automatically and randomly selected by the video conference provider 310. In the example of system 300, the participant using user client device 350 would be selected.

Still referring to FIG. 3, video conference provider 310 includes identity management services 317. Identity management services 317 includes a server or a system of servers that distributes public cryptographic keys, such as the IVKs from user-client-device generated persistent key pairs. These persistent key pairs may be generated by a user client device requesting a public-private key pair from an established certificate authority, or from the external user identity provider 315. Identity management services 317 binds public keys to user accounts where possible. In the case of a client device, such as client device 380, which does not rely on client software, identity management services 317 provides in encryption endpoint to service the user of such a device during end-to-end encrypted videoconferences.

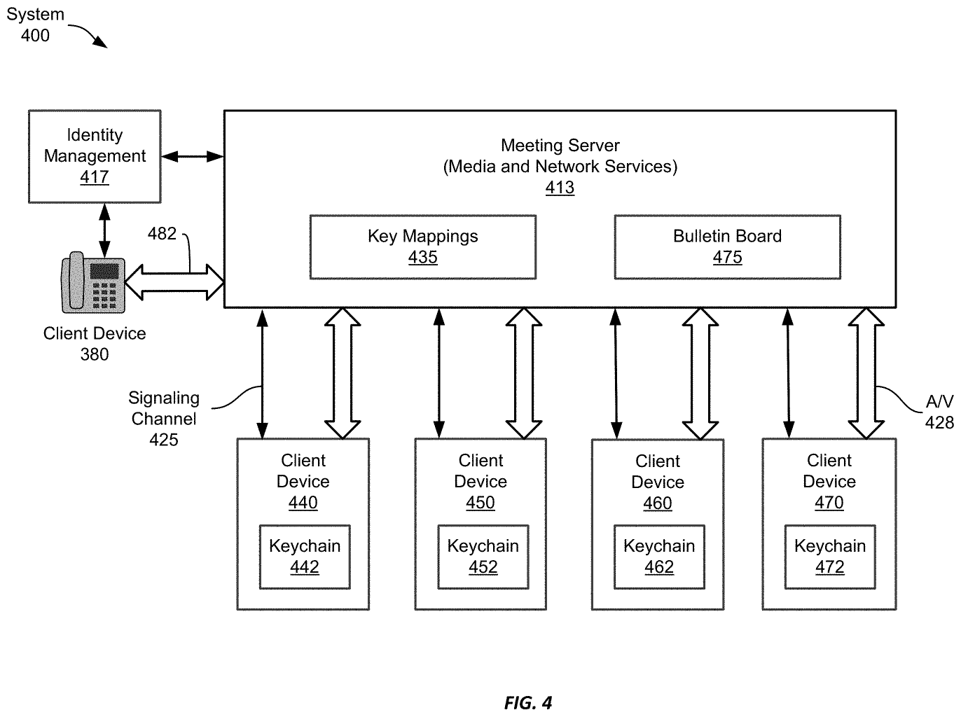

Referring to FIG. 4, FIG. 4 shows another example system 400 for including long-term key management for end-to-end encryption of videoconferencing information. Example system 400 includes meeting server 413. Meeting server 413 may also be referred to as a multimedia router and can be implemented by the real-time media servers 212 working with the network services servers 214. The meeting server 413 maintains stored representations of the meetings and sub-meetings taking place in the system so that the meeting server can keep track of the status of meetings and sub-meetings without constantly exchanging this information with client devices. Some client devices also maintain stored representations of the meetings or sub-meetings to which an associated participant or host is subscribed so that virtual meeting rooms can be displayed to the users.

In system 400, meeting server 413 maintains key mappings 435. In some examples, key mappings 435 include one or more database tables which show bindings of IVKs with device identifiers (device IDs) and user identifiers (user IDs) connected with user accounts. The device IDs identify client devices used by specific users, which have generated persistent key pairs including the IVKs as well as the ISKs. The key mappings may alternatively, or in addition, be stored in identity management services 417. Each persistent, client-generated key pair includes the public IVK and a private ISK. Key mappings 435 can also include key-wrapping keys, which are synchronized with copies of key-wrapping keys stored on user client devices. A key-wrapping key is used to encrypt persistent key pairs for storage in a client device keychain, such as an operating system keychain for a computing device. In this example, each instance of a persistent key pair assigned to the client device is wrapped in a randomly generated key-wrapping key. The key-wrapping keys provides the capability for multiple users of a device, each with a personal system account, to each independently store their own copy of the persistent key pair in a device keychain. A key-wrapping key prevents one user from being able to access the other's instance of the keys for the client device.

Continuing with FIG. 4, meeting server 413 is connected with client device 440, which includes keychain 442 for the storage of its client-generated, persistent key pair. Similarly, meeting server 413 is connected to client device 450 with keychain 452, client device 460 with keychain 462, and client device 470 with keychain 472. Each of these user client devices is connected to meeting server 413 by a signaling channel 425 and by an audio/video (A/V) channel 428. The signaling channel is used to distribute cryptographic messages between participants in a meeting. The cryptographic messages are used to distribute keys and establish end-to-end encrypted tunnels between participants using each participant's device IVK. Server 413 does not need to decrypt meeting information flowing through the A/V data streams. The A/V channel in this example also includes chat messages. Client device 380, discussed with respect to FIG. 3, has its security managed via signaling channels connected to identify management services 417 and its audio-only stream 482 is established with meeting server 413 by identity management services 417.

In the example of FIG. 4, meeting server 413 also includes an optional cryptographic bulletin board 475, which is made available to all users during videoconferences employing end-to-end encryption. Chat messaging can be end-to-end encrypted for videoconferences with end-to-end encryption. In such a case, group chats may not be possible, though a separate, common encryption key for group chats may be used to enable group chats in some end-to-end encrypted video conferences. Therefore, participants can post group messages to the bulletin board for all others to see; the server and user client devices make use of the signaling channel 425 to post these messages and read the bulletin board. Meeting server 413 controls the bulletin board, as it controls the signaling channel itself.

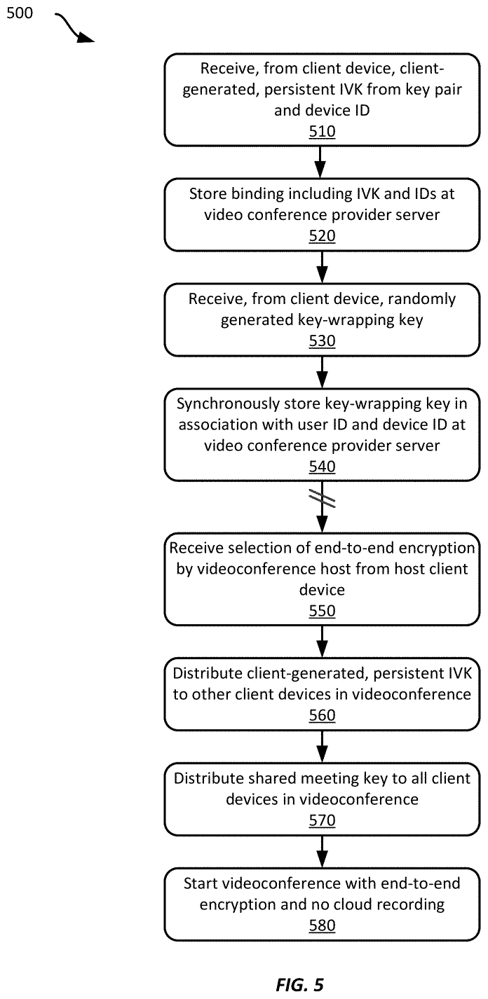

Referring now to the method 500 illustrated in FIG. 5, FIG. 5 shows an example method 500 for a video conference provider's long-term key management for end-to-end encryption of videoconferencing information. The description of the method 500 in FIG. 5 will be made with reference to the system 300 shown in FIG. 3 and system 400 shown in FIG. 4; however any suitable system according to this disclosure may be used, such as the example systems 100 and 300, shown in FIGS. 1 and 2.

At block 510, meeting server 413 receives a client-generated, persistent IVK, as well as the device ID from a client device. As an example, meeting server 413 may receive this information from client device 440 over signaling channel 425. The client device may generate a key pair and provide the public key when client software is first installed, or the device is first registered with the video conference provider. Alternatively, or in addition, this process may take place the first time a user of the client device participates in a meeting with end-to-end encryption activated. This information is stored at block 520 as a binding in key mappings 435 of meeting server 413. A new key pair may be generated due to some occurrence at the client device. For example, when the user client device is reset, or new client software is installed, or a participant is removed during a meeting. In this case, the server receives the new IVK and can overwrite the previously stored key in key mappings 435.

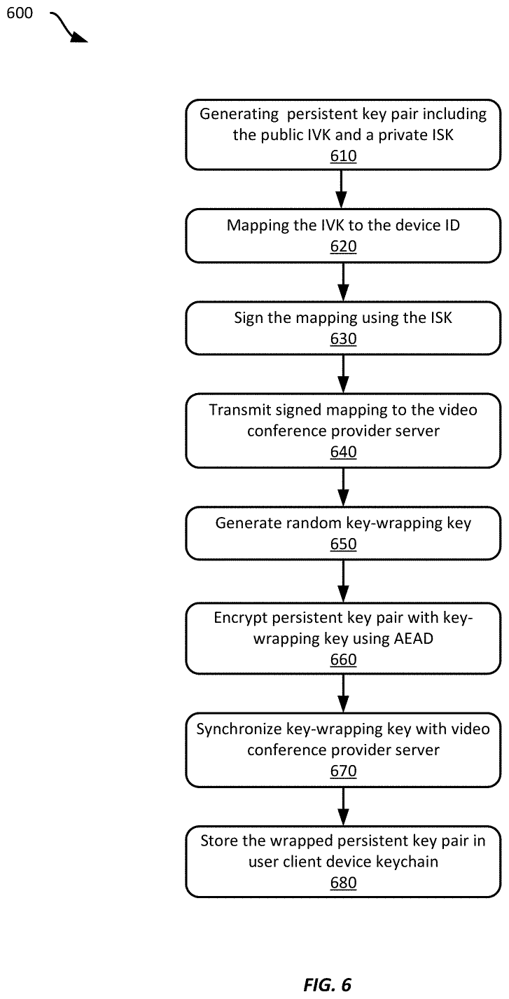

At block 530, meeting server 413 receives the randomly generated key-wrapping key from client device 440. As previously discussed, the key-wrapping key is used to encrypt persistent key pairs for storage in a client device keychain for a specific user. Other users may us the same device-based ISK for encrypting a videoconference but would use a different key-wrapping key. At block 540, this key-wrapping key is synchronously stored in association with the user ID and device ID at the video conference provider. As an example, the key-wrapping key may also be stored in key mappings 435. The key-wrapping key is kept synchronized between the video conference provider servers and the client device. If the client device generates a new persistent key pair, and thus supplies a new IVK to the video conference provider, the same key-wrapping key can be provided back to the client device so that it can be used for the new pair, and can optionally be re-used until the client device is de-provisioned. The key-wrapping key can provide an additional layer of security, and permits the same persistent key pair to be stored on the client device for multiple users of the device, as will be discussed in further detail below with respect to FIG. 6. The key-wrapping key can be updated if necessary, and can be selectively deleted in response to a provisioning status of the client device, for example, deleted if and when the system becomes aware of the client device being discarded.

The first part of method 500, described above may take place once or fewer times than the second part of method 500, described below, which describes how a videoconference is initiated with end-to-end encryption using the client device managed keys. At block 550, meeting server 413 receives a selection of end-to-end encryption by a videoconference host. The videoconference host, as an example, may be initiating the videoconference from client device 340 in system 300 of FIG. 3. The host may select a checkbox or similar display element in the graphical user interface of the videoconferencing client application, and such a selection can be communicated to meeting server 413 over the signaling channel. At block 560, meeting server 413 distributes the client-generated, persistent IVK to other participants in the videoconference. This process can take place for all of the other client devices running the client application involved in the videoconference, distributing client device IVKs as needed to allow each device to communicate with the others. At block 570, meeting server 413 distributes a shared meeting key to all of the participant client devices. The shared meeting key establishes the rights of the participants to access the particular videoconference and participate in the particular meeting and is used by both participants and the meeting server. The shared meeting key is created for a meeting independently of whether the meeting uses end-to-end encryption. At block 580, the videoconference is started with per client, end-to-end encryption, and optionally, cloud recording features disabled, since cloud recording may require the server to decrypt the media streams.

Referring now to the method 600 illustrated in FIG. 6, FIG. 6 shows an example method 600 for providing long-term key management for end-to-end encryption of videoconferencing information. The description of the method 500 in FIG. 5 will be made with reference to the system 400 shown in FIG. 4; however any suitable system according to this disclosure may be used, such as the example systems 100, 200, and 300, shown in FIGS. 1, 2, and 3.

At block 610 of method 600, a videoconferencing client device such as client device 440 generates the persistent key pair including the public IVK and private ISK. As an example, the key pair can be generated using public key encryption and signing services provided by a trusted authority. For example, standards such as RSA or EdDSA (Ed25519) can be used. Digital signing can be accomplished, as an example, using libsodium's EdDSA implementation directly. Automated public key encryption can also be provided, as an example, by libsodium. The client device generates the persistent, long-term signing key pair:
(IVKᵢ, ISKᵢ)←Sign.KeyGen( ).

At block 620, the client device maps the IVK to the device ID and at block 630, the client device signs the mapping with sign.sign under using the ISK, ISKᵢ to produce the mapping:
<(i, deviceID)->IVKᵢ,

At block 640, the client device transmits the key mapping to the video conference provider meeting server 413 and/or identity services 417. The client device persists the key pair indefinitely for itself and secures the ISK using whatever mechanisms the local hardware and operating system provide. The ISK never leaves the device and can be excluded from any cloud backups of the device. A client device may lose its long-term key pair after an operating system reinstall, a device reset, a disk corruption, a videoconferencing app reinstall, etc. In such a case, the device appears to the videoconferencing provider as a new device and goes through the long term key pair generation and any provisioning process in the same manner as a new device.

Still referring to FIG. 6, at block 650, the client device 440 generates a random key-wrapping key (KWK). The client device encrypts the persistent key pair with this server synchronized KWK at block 660 using automated encryption with additional data (AEAD). As an example, after initially generating the key pair with ISKᵢ, the client device generates a 32-byte random string KWK. The client device defines:
Context←“[Name]-1-ClientOnly-KDF-SecretStore”,
   where the name can be selected as appropriate, and then computes:
C←CtE1-Enc(K=KWK, H=Context, M=ISKL),
   where H is the associated data parameter for the AEAD. For CtE1, HMACSHA256 can be used as a commitment function and libsodium's cyrpto_aead_chacha20poly1305_ietf can be used for the AEAD.

At block 670, the client device synchronizes the KWK with the video conference provider server, for example, meeting server 413, by transmitting the key-wrapping key to the server with the user ID and device ID information. By “synchronizing” the key-wrapping key, what is meant is that the same key-wrapping key can be used throughout the active life of the client device and the user ID account, since it is tied to the user ID and not only to the device ID. If a new persistent key pair is generated because client software is upgraded or the client device is reset, as long as the client device can be identified and is assigned to the same user ID, the key-wrapping key can optionally be sent to the client device to wrap the new persistent key pair, and the wrapped new persistent key pair can be stored in the keychain.

At block 680, the client device stores the wrapped persistent key pair in the user's device keychain. When a device is de-provisioned, the keychain entry can be deleted so that keys cannot be recovered from the device. If two users access the videoconferencing service using the same device, the KWK prevents one user from being able to access the other user's persistent key pair.

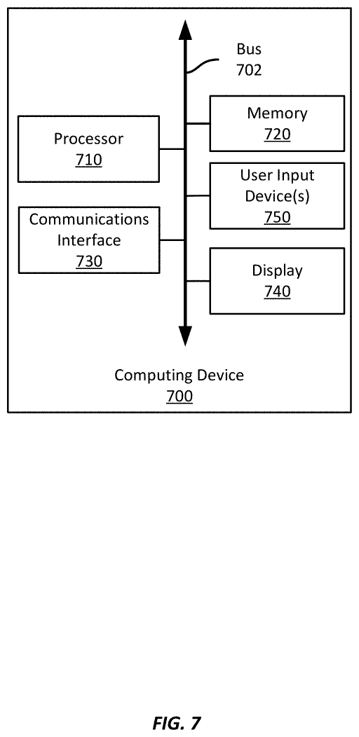

Referring now to FIG. 7, FIG. 7 shows an example computing device 700 suitable for use in example systems or methods for long-term key management for end-to-end encryption of videoconferencing information. The example computing device 700 includes a processor 710 which is in communication with the memory 720 and other components of the computing device 700 using one or more communications buses 702. The processor 710 is configured to execute processor-executable instructions stored in the memory 720 to perform one or more methods for providing long-term key management for end-to-end encryption of videoconferencing information, such as part or all of the example method 500, described above with respect to FIG. 5, or of the example method 600, described above with respect to FIG. 6. The computing device, in this example, also includes one or more user input devices 750, such as a keyboard, mouse, touchscreen, video input device (e.g., one or more cameras), microphone, etc., to accept user input. The computing device 700 also includes a display 740 to provide visual output to a user.

The computing device 700 also includes a communications interface 730. In some examples, the communications interface 730 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A system comprising:
a processor; and
at least one memory device including instructions that are executable by the processor to cause the processor to:
receive, a client-generated, persistent key from a user client device;
receive a device identifier (device ID) corresponding to the user client device;
store the client-generated, persistent key in the at least one memory device in association with the device ID for the user client device, the client-generated, persistent key configured for per client end-to-end encryption;
distribute the client-generated, persistent key to at least one participant in a videoconferencing session including the user client device; and
end-to-end encrypt a videoconference including the user client device and the participant using the client-generated, persistent key.

2. The system of claim 1, wherein the instructions are executable by the processor to cause the processor to receive an end-to-end encryption selection at a host client device, the client-generated, persistent key being distributed to the at least one participant based on the end-to-end encryption selection.

3. The system of claim 2, wherein the instructions are executable by the processor to selectively disable a cloud recording feature based on the end-to-end encryption selection.

4. The system of claim 1, wherein the instructions are executable by the processor to cause the processor to:
receive a key-wrapping key from the user client device, the key-wrapping key configured to encrypt a client-generated, persistent key pair including the client-generated, persistent key, for storage in a keychain of the user client device;
store the key-wrapping key in the at least one memory device in association with the device ID and a user identifier (user ID); and
selectively delete the key-wrapping key responsive to a provisioning status of the user client device.

5. The system of claim 1, wherein the instructions are executable by the processor to cause the processor to overwrite any previously stored persistent key corresponding to the device ID in response to receiving the client-generated, persistent key.

6. The system of claim 1, wherein the instructions are executable by the processor to cause the processor to distribute a shared meeting key in association with the videoconferencing session.

7. The system of claim 1, wherein the instructions are executable by the processor to cause the processor to establish a cryptographic bulletin board for the videoconferencing session.

8. A method comprising:
receiving, by a video conferencing system, a persistent key and a device identifier (device ID) corresponding to a user client device;
storing, by the video conferencing system, the persistent key in association with the device ID of the user client device, the persistent key configured for per client end-to-end encryption;
distributing, by the video conferencing system, the persistent key to at least one participant in a videoconferencing session including the user client device; and
end-to-end encrypting a videoconference including the user client device and the participant using the persistent key.

9. The method of claim 8, further comprising receiving an end-to-end encryption selection at a host client device, the persistent key being distributed to the at least one participant based on the end-to-end encryption selection.

10. The method of claim 9, further comprising selectively disabling a cloud recording feature based on the end-to-end encryption selection.

11. The method of claim 8, further comprising establishing a cryptographic bulletin board in the video conferencing system for the videoconferencing session.

12. The method of claim 8, further comprising distributing a shared meeting key in association with the videoconferencing session.

13. The method of claim 8, further comprising:
generating, by the user client device, a persistent key pair including the persistent key and an identity signing key (ISK);
producing, by the user client device, a mapping of the persistent key to the device ID;
signing, by the user client device, the mapping using the ISK; and
transmitting the mapping to the video conferencing system.

14. The method of claim 13, further comprising:
generating, by the user client device, a key-wrapping key;
encrypting, by the user client device, the persistent key pair using automated encryption with additional data based on the key-wrapping key to produce a wrapped persistent key pair;
transmitting the key-wrapping key to the video conferencing system; and
storing the wrapped persistent key pair in a keychain of the user client device.

15. The method of claim 14, further comprising:
receiving the key-wrapping key from the user client device by the video conferencing system;
storing the key-wrapping key by the video conferencing system in association with the device ID and a user identifier; and
selectively deleting the key-wrapping key responsive to a provisioning status of the user client device.

16. A non-transitory computer-readable medium comprising code that is executable by a processor in a videoconferencing client device for causing the processor to:
generate a persistent key pair including an identify verifying key (IVK) and an identity signing key (ISK);
produce a mapping of the IVK to a device ID for the videoconferencing client device;
sign the mapping using the ISK;
transmit the mapping to a video conference provider, the mapping being configured to enable the video conference provider to provide per client end-to-end encryption; and
encrypt a videoconference including the videoconferencing device client using the ISK.

17. The non-transitory computer-readable medium of claim 16, wherein the code that is executable for causing the processor to:
generate a key-wrapping key;
encrypt the persistent key pair using automated encryption with additional data based on the key-wrapping key to produce a wrapped persistent key pair;
transmit the key-wrapping key to the video conference provider; and
store the wrapped persistent key pair in a keychain of the videoconferencing client device.

18. The non-transitory computer-readable medium of claim 17, wherein the code that is executable for causing the processor to:
generate a new key pair; and
update the mapping at the video conference provider based on the new key pair.

19. The non-transitory computer-readable medium of claim 18, wherein the code that is executable for causing the processor to:
receive the key-wrapping key from the video conference provider;
encrypt the new key pair to produce a wrapped new key pair; and
store the wrapped new key pair in a keychain of the videoconferencing client device.

20. The non-transitory computer-readable medium of claim 16, wherein the code is executable for causing the processor to:
receive a shared meeting key; and
use the shared meeting key to access the videoconference.
